(19) United States
(12) Patent Application Publication
(10) Pub. No.: US 2005/0264666 A1
(43) Pub. Date: Dec. 1, 2005

(54) Image pickup device for reducing shading in vertical direction under long-term exposure

(75) Inventors: Takahiro Iwasawa, Kyoto (JP); Koujirou Yoneda, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/138,297

(22) Filed: May 27, 2005

(30) Foreign Application Priority Data
May 31, 2004 (JP) P2004-161540

(51) Int. Cl. H04N 5/335

(52) U.S. Cl. 348/308

(57) ABSTRACT

The pixel cell of the present invention comprises: a photodiode for storing an electrical charge according to a received light amount; a reading-out gate for reading out the electrical charge from the photodiode according to a reading-out pulse; and a charge storage unit for storing the electrical charge outputted from the photodiode through the reading-out gate. The reset action of the charge storage unit is continued even under a long-term exposure.

### BACKGROUND OF THE INVENTION

1. Field of the Invention

The present invention relates to an image pickup device using a solid state image pickup element and, more specifically, to a technique for suppressing shading in the vertical direction under a long-term exposure.

2. Description of Related Art

The applicants of the present invention have proposed an MOS type solid state image pickup device (see Japanese Patent Unexamined Publication No. 2003-46864). The solid state image pickup device is comprised of a pixel cell unit, a row scanning unit, a signal processing unit, a load unit, a column scanning unit, and an AND unit. The pixel cell unit is constituted by a large number of pixel cells arranged in matrix. Each of the pixel cells comprises a photodiode (photoelectric conversion element) for storing the electrical charge according to the received light amount during exposure and a charge storage unit for temporarily storing the electrical charge outputted from the photodiode. The electrical charge stored in the photodiode is read out as the pixel signal. Each pixel cell is selected in order by each row by the reading-out pulse and the reset pulse from a row scanning circuit. In the pixel cell of each row, the electrical charge stored in the photodiode of each cell is read out by the reading-out pulse and transmitted to the charge storage unit. The electrical charge stored in the charge storage unit is discharged to the output signal line by the reset pulse and, further, is transferred to the signal processing unit. The pixel signal for one row, which is transferred to the signal processing unit, is outputted by one column by the column scanning pulse of the column scanning circuit.

The solid state image pickup device supplies the reset pulse only to the pixel cell of the selected row and increases the potential of the charge storage unit of the selected row to a high level, so that the amplifying gate becomes connected for outputting the pixel signals. Inversely, the potential of the charge storage unit of the pixel cell of the unselected row is maintained to a low level for keeping the amplifying gate unconnected so as not to output the pixel signals to the output signal line.

Specifically, the potential of the charge storage unit is set to be the potential of the supply voltage which is common to the pixel cells by the reset pulse. Then, the electrical charge stored in the photodiode is read out to the charge storage unit by the reading-out pulse. The electrical charge (pixel signal) read out to the charge storage unit is amplified by the amplifying gate and outputted. At last, the electrical charge in the charge storage unit is cleared by the reset pulse. By successively performing a series of these actions by each pixel cell of each row, the pixel signals are read out.

The reading out actions of the pixel cell in the image pickup device under a long-term exposure will be described by referring to FIG. 7. In FIG. 7, VD is a vertical driving signal, HD is a horizontal driving signal, VSTART is an image-pickup start timing pulse, RESET is a reset signal, READ is a reading-out signal, LSELn is an n^{th} row selection pulse, LSELn+1 is n+1^{th} row selection pulse, and LSELn+2 is n+2^{th} row selection pulse. RSTn is an AND (reset pulse 104) between RESET and LSELn, RDn is an AND (reading-out pulse) between READ and LSELn, RSTn+1 is an AND (reset pulse) between RESET and LSELn+1, RDn+1 is an AND (reading-out pulse) between READ and LSELn+1, RSTn+2 is an AND (reset pulse) between RESET and LSELn+2, and RDn+1 is an AND (reading-out pulse) between READ and LSELn+1.

The time for receiving light (exposure time) in the photodiode is determined by a frame rate (interval between any VD signal and the next VD signal) which is set beforehand. Selection and unselection of the pixel cells are repeated in order by a row unit. The electrical charge of the photodiode in the selected row is read out. In the photodiode while being unselected, the electrical charge according to the optical information is stored. For the pixel cell to be selected, the VSTART pulse is applied for driving the scanning circuit. The reading out signal READ and the reset signal RESET are applied to the selected row. In the selected row, the AND between the row selection signal LSEL and the reading-out signal READ becomes the reading-out pulse RD. Further, the AND between the selected signal LSEL and the reset signal RESET becomes the reset pulse RST. In the selected row, the reading-out pulse RD and the reset pulse RST are supplied to the pixel cell part and the above-described reading-out process is carried out. As a result, the pixel signal is outputted.

When it is operated by the set frame rate, the exposure time of the photodiode is determined by the interval between a VD signal and the next VD signal, which corresponds to exposure time E1. In the meantime, the long-term exposure is an action which achieves exposure for the time over the two VD signals. It can be achieved by not applying the VSTART pulse to the row scanning circuit which selects the row so as not to generate the row selection pulse LSEL. In that state, the reading-out pulse RD and the reset pulse RST reaching the pixel cell are not applied so that the electrical charge of the photodiode is not read out. Thus, it is to be stored for a long time. When this scanning is performed, the exposure time in the long-term exposure corresponds to exposure time E2 (=2E1).

FIG. 8 shows the states of signals of each kind, e.g., the pixel signal, a digital signal (ADC output) which is obtained by AD conversion at last, etc.

In the long-term exposure, selection of the row by each VD signal is stopped so that application of VSTART under the long-term exposure is stopped. When such operation is performed, the DC (direct current) level of the pixel signal outputted from the MOS sensor immediately after being read out is large and gradually becomes stable with a time constant. The pixel signal reaches the clamp circuit through the condenser. The clamp circuit clamps the pixel signal in the OB region at a timing of OB (optical black) clamp pulse for DC-regenerating it as the clamp level. However, the DC level immediately after being read out is large under the long-term exposure, so that it is gradually reduced with the time constant. Therefore, there is generated shading in the vertical direction in the DC-regenerated output (clamp level). As a result, there is the vertical shading generated in the digital signal which is obtained at last.

The difference of the levels in DC-regeneration becomes prominent as the time interval of the long-term exposure becomes longer. Thus, when the shading becomes as large as the ones appeared in the output image, the maximum time for using the long-term exposure becomes limited.

The reason for this is that the pixel cell becomes unselected during the long-term exposure and the charge storage unit becomes floated. By an emergence of dark current according to the time of the long-term exposure, the DC component in accordance with the time is generated in the charge storage unit.

### SUMMARY OF THE INVENTION

The present invention enables to perform long-term exposure while suppressing the shading.

The present invention enables to suppress the shading through suppressing generation of the dark current in the long-term exposure.

The present invention enables to suppress the shading by changing the drive pulse timing and the position of the OB clamp pulse without changing the configuration of the sensor which corresponds to the solid state image pickup device.

The image pickup device of the present invention comprises comprising a plurality of pixel cells and a signal output line to which said plurality of pixel cells are connected. Each of the pixel cells comprises: a photodiode for generating an electrical charge according to a received light amount as a pixel signal; a reading-out gate which is connected by an application of a reading-out pulse; a charge storage unit for storing the electrical charge of the photodiode through the reading-out gate; and a reset gate which is connected by an application of a reset pulse for resetting the electrical charge of the charge storage unit, and the reset pulse is applied to the reset gate even under a long-term exposure.

It is preferable to perform the long-term exposure by stopping the application of the reading-out pulse to the reading-out gate.

It is preferable that the image pickup device comprises: a row scanning circuit for selecting a plurality of pixel cells in a row direction by outputting a row selection signal; and an AND circuit for outputting the reading-out pulse and the reset pulse by obtaining the AND between the row selection signal and the reading-out signal and the AND between the row selection signal and the reset signal, wherein an application of the reading-out pulse to the reading-out gate is stopped by masking the reading-out signal for the AND circuit under the long-term exposure.

In this configuration, under the long-term exposure, the reset pulse for resetting the charge storage unit is applied at a constant timing. The electrical charge to be stored in the photodiode is continuously stored within the photodiode by not applying the reading-out pulse. Thereby, the long-term accumulation is achieved. Thus, the dark current of the charge storage unit is cleared by each pulse interval so that the flow of the dark current in the charge storage unit can be suppressed and the floating of the DC level can be suppressed.

Furthermore, the image pickup device of the present invention comprises: a plurality of pixel cells for outputting a pixel signal according to a received light amount; an output line for commonly connecting a plurality of the pixel cells; a clamp circuit for regenerating the pixel signal as a DC signal; and a CDS (co-related double sampling) circuit for taking a difference between a reference level and a signal level in the pixel signal, wherein the clamp circuit regenerates a dummy pixel signal as a DC signal, which is outputted as the pixel signal at least during a period of either a horizontal blanking period or a vertical blanking period, and the CDS circuit calculates an OB level by taking a difference between the dummy pixel signal and the reference level.

In this configuration, even in the long-term exposure at a reading-out timing similar to that of the conventional case, the signal in the dummy region is used for DC-regeneration without performing clamping in the OB region at the time of DC-regeneration.

### BRIEF DESCRIPTION OF THE DRAWINGS

The present invention is illustrated be way of example and not limitation in the figures of the accompanying drawings, in which like references indicate similar elements and in which:

FIG. 1 is a schematic block diagram for showing the configuration of a pixel cell of an image pickup device according to a first preferred embodiment of the present invention;

FIG. 2 is a block diagram of the image pickup device according to the first embodiment of the present invention;

FIG. 3 is a timing chart for showing the action for reading out the pixel column in the image pickup device according to the first embodiment of the present invention;

FIG. 4 is a schematic block diagram for showing the configuration of a signal processing system according to the first embodiment of the present invention;

FIG. 5 is a timing chart for showing the reading-out action of the image pickup device according to the first embodiment of the present invention;

FIG. 6 is a timing chart for showing the action of the clamp in the image pickup device according to a second preferred embodiment of the present invention;

FIG. 7 is a timing chart for showing the reading-out action of the image pickup device of the related art; and

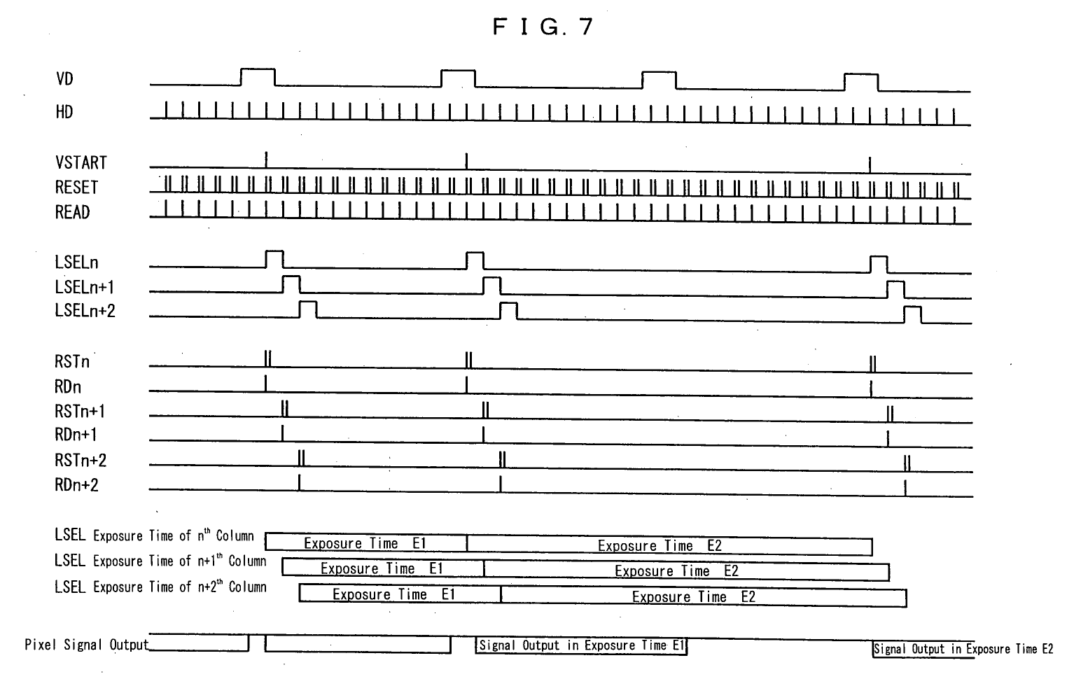

FIG. 8 is a timing chart for showing the action of the clamp in the image pickup device of the related art.

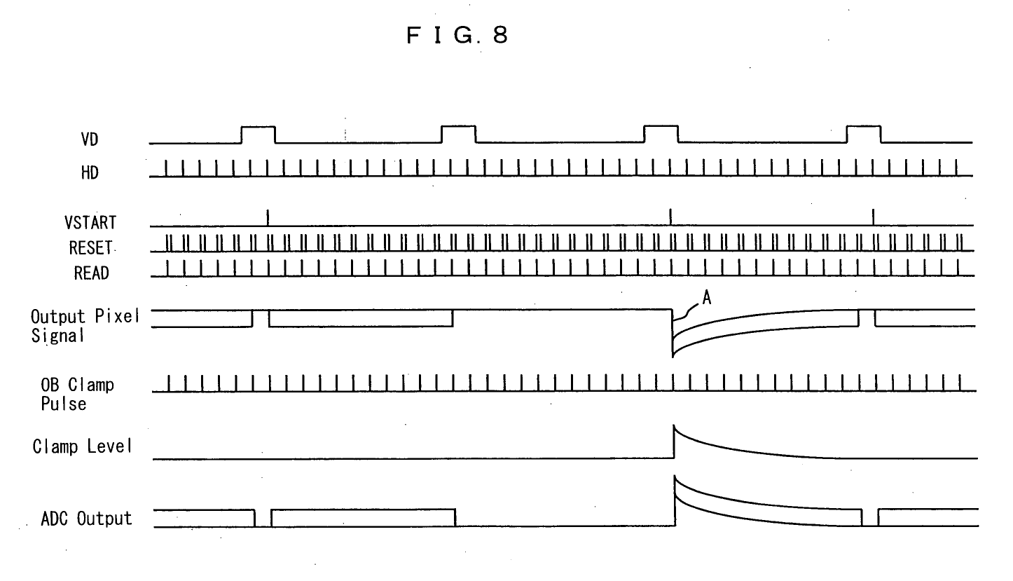

### DETAILED DESCRIPTION OF THE PREFERRED EMBODIMENTS OF THE INVENTION

The image pickup device according to the preferred embodiments of the present invention will be described in detail by referring to the accompanying drawings.

### First Embodiment

In the first embodiment, flow-out of the dark current is suppressed by resetting the charge storage unit even during the long-term exposure, through changing the pulse timing for the image pickup device under the long-term exposure without changing the configuration of the image pickup device.

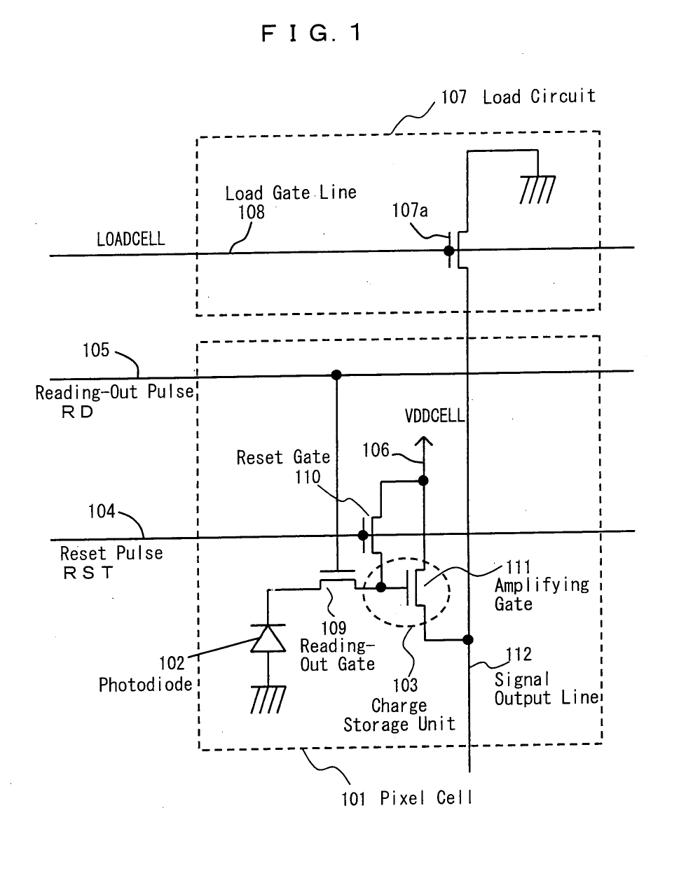

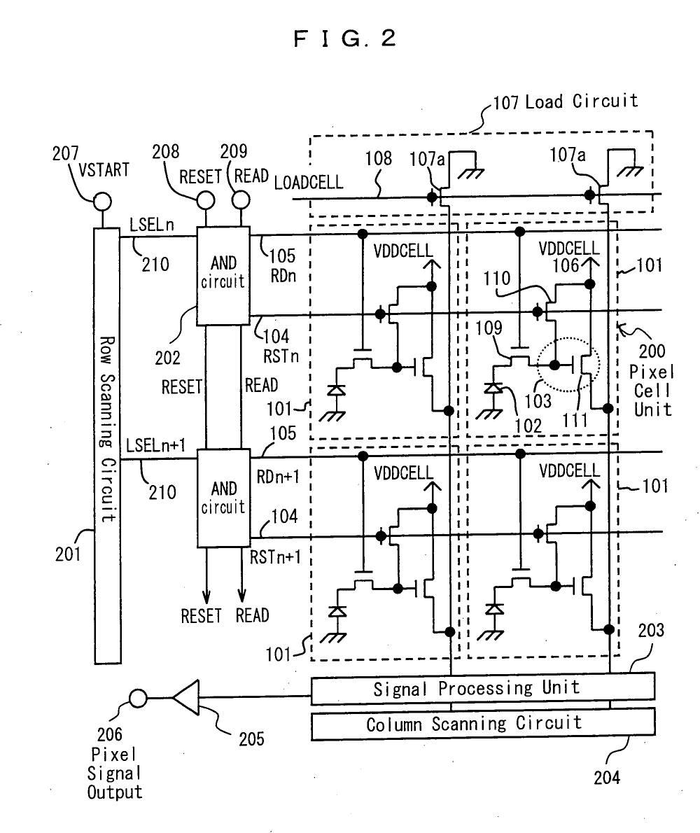

In FIG. 1 and FIG. 2, reference numeral 101 is a pixel cell. The pixel cell 101 comprises: a photodiode 102 for performing photoelectric conversion; a charge storage unit 103 for storing the electrical charge of the photodiode 102; a reading-out gate 109 for transferring (reading out) the electrical charge from the photodiode 102 to the charge storage unit 103; a reset gate 110 for discharging the electrical charge stored in the charge storage unit 103; and an amplifying gate 111 for amplifying the discharged electrical charge. A supply voltage signal (VDDCELL) is supplied to the reset gate 110 and the amplifying gate 111, respectively, through a common power line 106. A load circuit 107 comprises a load gate 107a which forms a source follower amplifier together with the amplifying gate 111. A load gate signal (LOADCELL) is applied to a load gate line 108 from the load cell. Reference numeral 104 is a reset pulse line to which a reset pulse RST is applied, while 105 is a reading-out line to which a reading-out pulse RD is applied.

In the pixel cell 101, when the reset gate 110 is connected by an application of the reset pulse RST from the reset pulse line 104, the high-level potential of the supply voltage signal (VDDCELL) is supplied to the charge storage unit 103 through the common power line 106. Thereby, the amplifying gate 111 is connected so that, through the amplifying gate 111, the voltage according to the electrical charge stored in the charge storage unit 103 is outputted to an output signal line 112 which is connected to the load circuit 107. This voltage is the reference potential.

The photodiode 102 generates the electrical charge in accordance with received light information (received light amount). When the reading-out gate 109 is connected by an application of the reading-out pulse RD from the reading-out pulse line 105, the electrical charge of the photodiode 102 is supplied to the charge storage unit 103. The stored electrical charge in the charge storage unit 103 is outputted to the output signal line 112 through the amplifying gate 111 which is being connected by the application of the reset pulse RST. This is the signal potential. The pixel signal is the signal based upon the difference between the reference potential and the signal potential.

In FIG. 2, reference numeral 200 is a pixel cell group in which the pixel cells are arranged in matrix, 201 is a row scanning line, 202 is an AND circuit, 203 is a signal processing unit, 204 is a column scanning circuit, 205 is a buffer, 206 is a pixel signal output unit, 207 is an applying terminal of the starting pulse VSTART, 208 is an applying terminal of the reset signal (RESET), 209 is an applying terminal of the reading-out signal (READ), and 210 is a signal line of the selection signal (LSEL). The signal processing unit 203 reads out the pixel signal by the potential difference between the reference potential and the signal potential at two points on the output signal line 112. The “n” and “n+1” inserted at the end of LSEL, RD, and RST indicates being the n^{th} row and the n+1^{th} row, respectively. The output action of the reference potential and the signal potential is performed by supplying the reading-out pulse RD and the reset pulse RST to the reading-out gate 109 and the reset gate 110. Further, the charge storage unit 103 is merely an intersection point on the block diagram, however, it corresponds to a PN junction within an integrated circuit. It can be formed by a capacity which can store a specific electrical charge.

The image pickup device as shown in FIG. 2 reads out the pixel signal which is outputted in the pixel cell 101 according to the received light amount. The pixel cells 101 are arranged in L-rows×M-columns thereby forming the pixel cell group 200. Each pixel cell 101 is selected in order by the reading-out pulse RD and the reset pulse RST, which are outputted from the AND circuit 292 by the AND between the row selection signal LSEL and the reset signal RESET from the row scanning circuit 201 in the AND circuit and by the AND between the row selection signal 21OLSEL and the reading-out signal READ. The pixel signal of the selected pixel cell 101 is transferred to the signal processing unit 203 through the output signal line 112. The pixel signal for one row being transferred to the signal processing unit 203 is outputted by each column by the column-direction scanning pulse from the column scanning circuit 204.

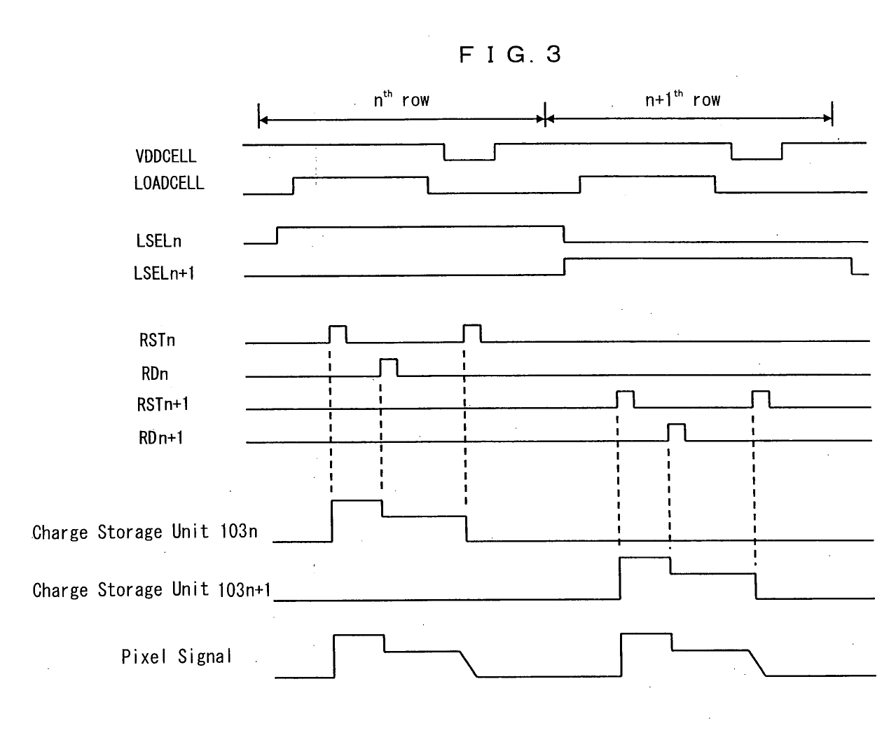

The timing chart showing the drive pulse of the image pickup device will be described by referring to FIG. 3. In FIG. 3, VDDCELL is the supply voltage signal, LOADCELL is the load gate signal, LSEL is the row selection signal, RST is the reset pulse, and RD is the reading-out pulse. The “n”, “n+1” indicates being the n^{th} row and the n+1^{th} row, respectively. The charge storage unit n is the charge storage unit within the n^{th} pixel cell, and the charge storage unit n+1 is the charge storage unit within the n+1^{th} pixel cell. The pixel signal is the output of the pixel signal output unit 206.

(1) The pixel cell in the n^{th} row is selected by the n^{th} row selection signal LSELn from the row scanning circuit 201. In the pixel cell 101 of the n^{th} row, the reset pulse RSTn becomes the high-level potential for setting the potential of the charge storage unit 103 to be the high-level potential of the supply voltage signal VDDCELL, and the reset gate 110 is connected. Thereby, the potential of the charge storage unit 103 becomes the high-level potential of the supply voltage signal VDDCELL. The high-level potential according to this is outputted from the amplifying gate 111 and the potential of the output signal line 112 is increased.

(2) When the reset pulse RSTn becomes the low-level potential, the reset gate 110 becomes disconnected. In that state, the charge storage unit 103n maintains the high-level potential.

(3) The reading-out pulse RDn becomes the high-level potential and the reading-out gate 109 becomes connected. Thereby, the electrical charge stored in the photodiode according to the light information is read out to the charge storage unit 103n. As a result, the potential of the charge storage unit 103n drops. In accordance with the potential drop in the charge storage unit 103n, the potential in the output unit of the amplifying gate 111 drops, thereby decreasing the potential of the output signal line 112.

(4) The reading-out pulse RDn becomes the low-level potential and the reading-out gate becomes disconnected. The signal processing unit 203 measures the potential difference of the output signal line 112 in above-described (1) and (3) as the pixel signal. Then, the supply voltage signal VDDCELL becomes the low-level potential.

(5) For setting the potential of the charge storage unit 103n to be the low-level potential of the supply voltage signal VDDCELL, the reset pulse RSTn becomes the high-level potential and the reset gate 110 becomes connected. Thereby, the potential of the charge storage unit 103n becomes low level and the amplifying gate 111 becomes disconnected.

In this manner as described above, the output action of the pixel signal of the n^{th} pixel cell 101 is completed. Then, the n^{th} row selection signal LSELn, becomes low level and the n^{th} row becomes unselected. Then, the n+1^{th} row selection signal becomes high level and the n+1^{th} row becomes the selected line. The action of the n+1^{th} row is the same as that of the above-described n^{th} row so that the description will be omitted.

The pixel cell 101 is arranged in L-rows×M-columns and the same pulse drive as the one described above is performed in the region with no pixel cells (dummy pixel region) in the L-rows×M-columns. In the dummy pixel region, it is possible to output signals which are not influenced by the dark current of the charge storage unit 103. The output signals of the dummy pixel region are the signals outputted in the horizontal blanking period and the vertical blanking period.

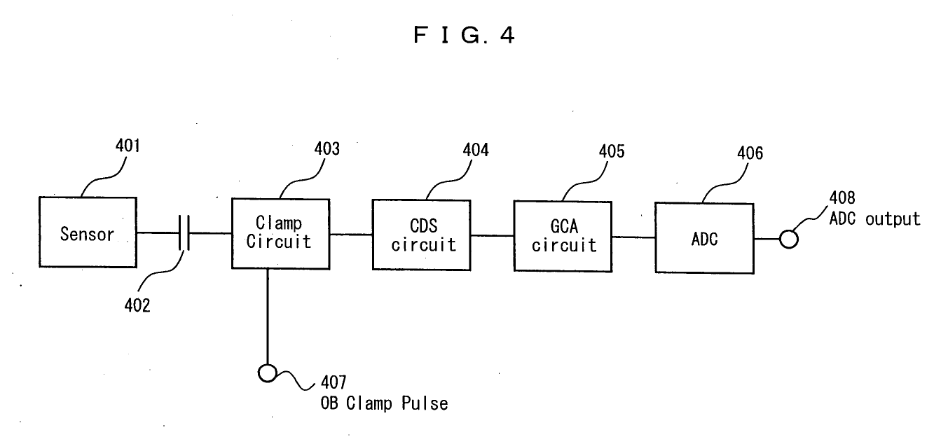

FIG. 4 is an illustration for showing the signal processing system of the image pickup device. The signal processing system is comprised of: a sensor 401 which corresponds to a MOS sensor; a condenser 402 for eliminating the unnecessary DC component contained in the output of the sensor 401; a clamp circuit 403 for clamping the pixel signal of the OB region at a timing of the OB clamp pulse so as to regenerate the DC as the signal; a CDS circuit 404 for taking the difference between the reference level (the reference level of the black level)and the signal level by each pixel signal with the OB level being the operating point; a GCA (gain control amp) circuit 405 which can control the gain amount; an ADC unit (analog-to-digital converter) 406 for converting the analog signal to the digital signal; and a clamp pulse input unit 407 for receiving the OB clamp pulse which becomes the timing pulse when regenerating the DC in the clamp circuit 403.

The signal passing from the photodiode to the ADC unit 406 within the sensor 401 passes through several stages of the amplifiers (not shown) as the analog signal. Thus, the 1/f noise as the amp noise is cancelled by taking the difference between the cancel reference level of 1/f noise and the signal level by the CDS circuit 404.

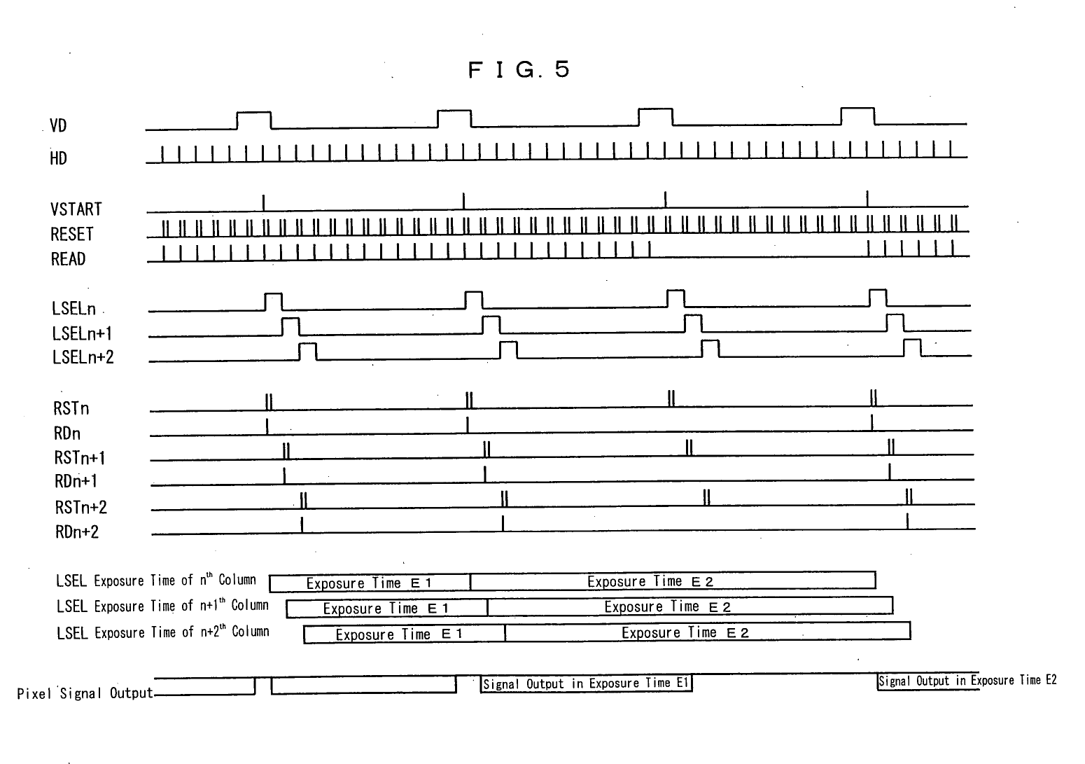

The action will be described by referring to FIG. 5. FIG. 5 is the timing chart of the action for the n^{th} row, the n+1^{th} row, and the n+2^{th} row. Each row is denoted by “n”, “n+1”, and “n+2”, respectively. VD is the vertical driving signal, HD is the horizontal driving signal, VSTART is the starting pulse, RESET is the reset signal, READ is the reading-out signal, LSELn is the n^{th} selection signal, LSELn+1 is the n+1^{th} selection signal, LSELn+2 is the n+2^{th} selection signal, RSTn is the n^{th} reset pulse, RSTn+1 is the n+1^{th} reset pulse, RSTn+2 is the n+2^{th} reset pulse, RDn is the n^{th} reading-out pulse, RDn+1 is the n+1^{th} reading-out pulse, and RDn+2 is the n+2^{th} reading-out pulse.

First, for performing the regular reading-out, the starting pulse VSTART is applied by each VD interval. With the starting pulse VSTART as a trigger, the row. selection signals LSELn, LSELn+1, and LSELn+2 are generated. The row selection signals LSELn, LSELn+1, and LSELn+2 are moved in order by every horizontal scanning period H by the row selection circuit 201 for shifting the row to be selected so as to determine the selected rows n, n+1, and n+2 of the pixel cells 101. In the pixel cells of the selected n^{th} , n+1^{th} , and n+2^{th} rows, the reading-out pulse RDn, RDn+1, RDn+2, and the reset pulse RSTn, RSTn+1, RSTn+2 are applied, which are the ANDs between the reading-out signal READ and LSELn, LSELn+1, LSELn+2, and the ANDs between the reset signal RESET and LSELn, LSELn+1, LSELn+2, respectively.

For simplifying the explanation, only the action of n^{th} row will be described. The pixel cell 101, first, resets the charge storage unit 103 by the reset pulse RSTn, and the electrical charge stored in the photodiode 102 is transferred to the charge storage unit 103 by the reading-out pulse RDn. Then, it is outputted to the output signal line 112 by the amplifying gate 111 and the pixel signal is propagated to the signal processing unit 203. Subsequently, the potential of the charge storage unit 103 is increased to be high level by the supply voltage signal VDDCELL so that the charge storage unit 103 becomes unselected.

During the operation of the long-term exposure, the starting pulse VSTART is applied by each VD interval. With the starting pulse VSTART as a trigger, the row selection signal is generated. As in the regular action, the row selection signal LSELn is moved in order by every H by the row selection circuit 201 for shifting the row to be selected so as to determine the selected n^{th} row pixel cell 101. The reset pulse RSTn which is the AND between the reset signal RESET and the row selection signal LSELn is applied to the pixel cell 101 of the selected n^{th} row. The reading-out signal READ is masked during the long-term exposure so that the reading-out pulse RDn is not applied.

In the pixel cell 101, the charge storage unit 103 is reset by the reset pulse RSTn. However, the reading-out pulse RDn is not applied so that the electrical charge of the photodiode 102 is not read out to the charge storage unit 103 and remained to be stored on the photodiode 102. Subsequently, the potential of the charge storage unit 103 is increased to high level by the supply voltage signal VDDCELL so that the charge storage unit 103 is unselected. Through this action, the dark current flown in the charge storage unit 103 is cleared. Then, the electrical charge of the photodiode 102 is read out by performing the same reading-out action as that of the regular action for achieving the long-term accumulation. The exposure time E1 is the normal exposure and the exposure time E2 is the long-term exposure.

By achieving the long-term accumulation through the above-described action, the reset pulse RST is outputted to the charge storage unit 103 even under the long-term exposure. Thus, the dark current of the charge storage unit 103 can be canceled and it becomes possible to obtain an excellent pixel signal with no flown dark current. Due to this effect, the vertical shading can be suppressed.

Adjusting roll and suppression of the shading in the n^{th} row as described above is the same in the n+1^{th} row and the n+2^{th} row, so that the description will be omitted.

### Second Embodiment

In the second embodiment, the configuration of the image pickup device is not changed and also the driving pulse is the same as that of the conventional case. However, the vertical shading is suppressed by utilizing the DC-regeneration OB clamp pulse of the clamp circuit, which receives the pixel signal, in the dummy pixel region of the sensor and also by regenerating the OB level in the CDS circuit.

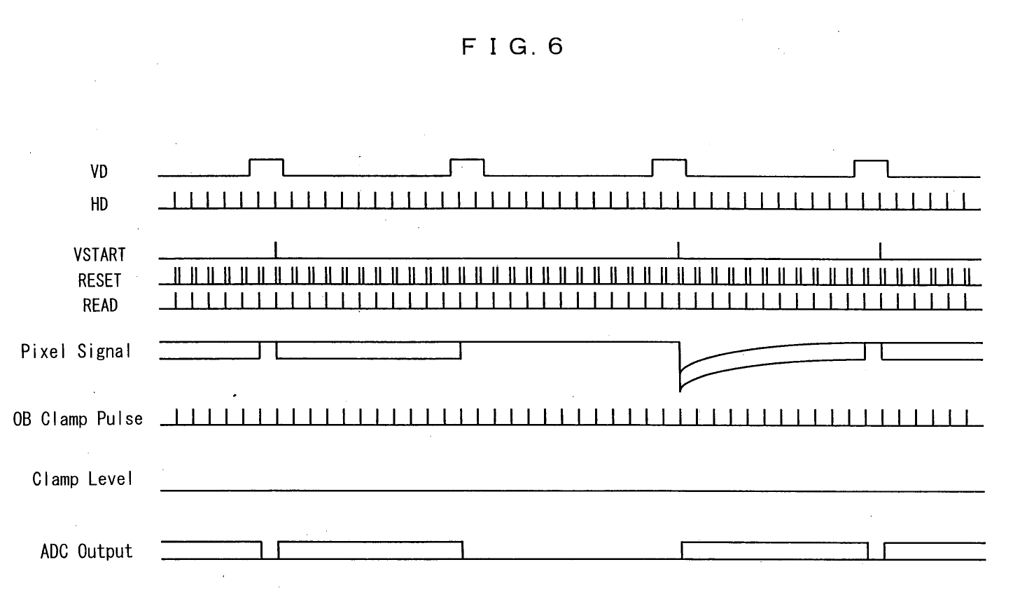

The action will be described hereinafter by referring to FIG. 6. The configuration of the image pickup device according to the second embodiment is the same as that of the image pickup device of the first embodiment. Thus, the configuration will be described by referring to FIG. 1, FIG. 2, and FIG. 4.

For performing the regular reading-out, the starting pulse VSTART is applied by each VD interval. With the starting pulse VSTART as a trigger, the row selection signals LSEL is generated. The row selection signal LSEL is moved in order by every horizontal scanning period H by the row selection circuit 201 for shifting the row to be selected so as to determine the pixel cell 101 of the selected row. In the pixel cell 101 of the selected row, the AND between the reading-out pulse READ of the reading-out signal and the row selection pulse LSEL, and the AND between the reset signal RESET and the row selection pulse LSEL are obtained to be applied to the pixel cell 101. In the pixel cell 101, first, the charge storage unit 103 is reset by the reset pulse RST and the electrical charge stored in the photodiode 102 is shifted to the charge storage unit 103. Then, it is outputted to the output signal line 112 by the amplifying gate 111 and the pixel signal is propagated to the signal processing unit 203. Subsequently, the potential of the charge storage unit 103 is increased to high level by the supply voltage signal VDDCELL so that the charge storage unit 103 becomes unselected.

During the operation of the long-term exposure, the pixel signal from the pixel cell 101 is not read out. Thus, the starting pulse VSTART is stopped during a prescribed accumulation time. Since the starting pulse VSTART is not applied, the row selection pulse LSEL is stopped. Therefore, it remains in the state where the reading-out pulse RD and the reset pulse RST are not applied to the pixel cell 101. In proportion to the time of stopped period, the flown dark current is generated in the charge storage unit 103. After a prescribed exposure time, the pixel signal is outputted by the same process as that of the regular reading-out. At this time, the dark current of the charge storage unit 103 is added to the pixel signal to be read out and the output signal becomes the DC component with the time constant. However, the pixel signal (dummy signal) in the dummy pixel region to which the pixel cell 101 is not connected can always output a constant DC level. The signal output of the dummy pixel region is outputted as the pixel signal in the horizontal blanking period and the vertical blanking period. The clamp circuit 403 performs the DC-regeneration by clamping the dummy signal part.

It will be specifically described in the followings. DC-regeneration of the clamp circuit 403 is determined by the reference voltage of the CDS circuit 404. That is, the clamp circuit 403 operates with the voltage on the CDS circuit 403 of the condenser 402 being the reference voltage. The pixel signal clamped by the clamp circuit 403 alternately outputs the field-through section and the signal section by a unit of the pixel cell 101 so that it passes through the CDS circuit 404. As a result, the signal in the dummy pixel region operates to be equal to the reference voltage of the CDS circuit 404. Therefore, it enables to perform the DC-regeneration with the constant voltage. Furthermore, the signal level of the field-through section is clamped to the power level of the image pickup device so that it is possible to regenerate the DC level which is equivalent to the OB level by using the dummy pixel. Thereby, it becomes possible to suppress the vertical shading after the CDS circuit 404.

As described above, by utilizing the signal in the dummy pixel region which outputs a constant DC level, it becomes possible to obtain the excellent pixel signal with no flown dark current. With this effect, the vertical shading can be suppressed.

The image pickup device of the embodiments as described above is the image pickup device which can suppress the vertical shading by changing the driving pulse and the signal processing pulse without changing the configuration of the sensor which corresponds to the solid state image pickup device. For example, it is useful as a mobile camera, cam-coder, surveillance camera and the like. Furthermore, it becomes possible to provide an image pickup device which is useful for obtaining an excellent image for achieving a supersensitive camera.

While the invention has been described and illustrated in detail, it is to be clearly understood that this is intended be way of illustration and example only and is not to be taken by way of limitation, the spirit and scope of this invention being limited only be the terms of the following claims.

1. An image pickup device, comprising a plurality of pixel cells and a signal output line to which said plurality of pixel cells are connected, wherein
each of said pixel cells comprises: a photodiode for generating an electrical charge according to a received light amount as a pixel signal; a reading-out gate which is connected by an application of a reading-out pulse; a charge storage unit for storing said electrical charge of said photodiode through said reading-out gate; and a reset gate which is connected by an application of a reset pulse for resetting said electrical charge of said charge storage unit, and
said reset pulse is applied to said reset gate even under a long-term exposure.

2. The image pickup device according to claim 1, which performs a long-term exposure by stopping an application of said reading-out pulse to said reading-out gate.

3. The image pickup device according to claim 1, comprising:
a row scanning circuit for selecting a plurality of pixel cells in a row direction by outputting a row selection signal; and an AND circuit for outputting said reading-out pulse and said reset pulse by obtaining an AND between said row selection signal and said reading-out signal and an AND between said row selection signal and said reset signal, wherein
an application of said reading-out pulse to said reading-out gate is stopped by masking said reading-out signal for said AND circuit under a long-term exposure.

4. The image pickup device according to claim 1, comprising:
a condenser for cutting an excessive DC component of said pixel signal;
a clamp circuit for regenerating said pixel signal with a cut DC component as a DC signal; and
a CDS circuit for taking a difference between a reference level and a signal level in said pixel signal.

5. An image pickup device, comprising:
a plurality of pixel cells for outputting a pixel signal according to a received light amount;
an output line for commonly connecting said plurality of pixel cells;
a clamp circuit for regenerating said pixel signal as a DC signal; and
a CDS circuit for taking a difference between a reference level and a signal level in said pixel signal, wherein
said clamp circuit regenerates a dummy pixel signal as a DC signal, which is outputted as said pixel signal at least during a period of either a horizontal blanking period or a vertical blanking period, and
said CDS circuit calculates an OB level by taking a difference between said dummy pixel signal and said reference level.

6. The image pickup device according to claim 5, wherein
said plurality of pixel cells are arranged two-dimensionally in a row direction and a column direction, the device comprising:
a row scanning circuit for performing scanning of said plurality of pixel cells in the row direction; and
a column scanning circuit for performing scanning of said plurality of pixel cells in the column direction.
